(19) United States
(12) Patent Application Publication
(10) Pub. No.: US 2015/0140937 A1
(43) Pub. Date: May 21, 2015

(54) ON-CHIP TRANSMIT AND RECEIVE FILTERING

(71) Applicant: Cambridge Silicon Radio Limited, Cambridge (GB)

(72) Inventors: Michael John Story, Cambridge (GB); Terence Chi-Fung Kwok, London (GB)

(73) Assignee: Cambridge Silicon Radio Limited, Cambridge (GB)

(21) Appl. No.: 14/150,145

(22) Filed: Jan. 8, 2014

Related U.S. Application Data
(63) Continuation-in-part of application No. 14/141,861, filed on Dec. 27, 2013.

(30) Foreign Application Priority Data
Nov. 19, 2013 (GB) 1320448.2

(51) Int. Cl. H04B 1/44; H04W 52/02; H04B 1/38

(52) U.S. Cl. CPC H04B 1/44; H04B 1/3833; H04W 52/028
USPC 455/78

(57) ABSTRACT

An integrated circuit chip including a chip pin configured to direct radio frequency signals on and off chip; a signal path from the chip pin which divides into a first signal path coupled to an input unit and a second signal path coupled to an output unit; a first filter between the chip pin and the input unit on the first signal path; a second filter between the chip pin and the output unit on the second signal path; a first switch coupling the first signal path to ground; and a second switch coupling the second signal path to ground; wherein the first and second switches are controllable to isolate the input unit from the output unit when the integrated circuit chip is transmitting a radio frequency signal, and to isolate the output unit from the input unit when the integrated circuit chip is receiving a radio frequency signal.

### BACKGROUND

Integrated circuit chips are used to transmit and receive wireless communications. Traditionally, the transmit circuitry is separate from the receive circuitry on the chip. It is common to use a single antenna, which may be on-chip or off-chip. In this case, the same chip pin is utilised to both (i) direct signals to be transmitted from the transmit circuitry to the antenna, and (ii) direct signals received by the antenna to the receive circuitry.

FIG. 1 illustrates on-chip transceiver circuitry used to connect a single antenna and chip pin to separate transmit and receive circuitry. The low noise amplifier (LNA) in receive circuitry 102 and the power amplifier (PA) in transmit circuitry 103 are arranged to receive a differential input from balun 104. The chip pin 101, off-chip filters 106 and off-chip antenna 105 are arranged on the unbalanced side of the balun.

A problem with utilising the same antenna and chip pin for both the transmit and receive circuitry is losses caused by the receive circuitry when the chip is transmitting a signal, and similarly losses and interference caused by the transmit circuitry when the chip is receiving a signal. The arrangement of FIG. 1 provides little isolation of the transmit and receive circuitry, and thus makes the design of an effective LNA difficult.

Additionally, there is increasing market demand for smaller products.

Thus, there is a need for transceiver circuitry with better transmitter/receiver isolation whilst utilising a small on-chip area and low power.

### SUMMARY OF THE INVENTION

According to a first aspect of the disclosure, there is provided an integrated circuit chip comprising: a chip pin configured to direct radio frequency signals on and off chip; a signal path from the chip pin which divides into a first signal path coupled to an input unit and a second signal path coupled to an output unit; a first filter between the chip pin and the input unit on the first signal path; a second filter between the chip pin and the output unit on the second signal path; a first switch coupling the first signal path to ground; and a second switch coupling the second signal path to ground; wherein the first and second switches are controllable so as to isolate the input unit from the output unit when the integrated circuit chip is transmitting a radio frequency signal, and to isolate the output unit from the input unit when the integrated circuit chip is receiving a radio frequency signal.

Suitably, the first switch couples the first signal path to ground between the input unit and the first filter.

Suitably, the second switch couples the second signal path to ground between the output unit and the second filter.

Suitably, the first and second filters comprise passive components which, when the integrated circuit chip receives a radio frequency signal, cause that received radio frequency signal to have a higher voltage on input to the input unit than when at the chip pin.

Suitably, the first filter comprises a first resonant circuit comprising a first capacitor and a first inductor.

Suitably, the first inductor is connected in series on the first signal path, and the first capacitor couples the first signal path to ground.

Suitably, the first capacitor is connected in series on the first signal path, and the first inductor couples the first signal path to ground.

Suitably, the first capacitor is a variable capacitor configured to tune the first filter to the received radio frequency signal.

Suitably, the second filter is configured to attenuate unwanted harmonic components of a signal output from the output unit.

Suitably, the second filter comprises a second resonant circuit comprising a second capacitor connected in parallel with a second inductor.

Suitably, the second resonant circuit is configured to attenuate first unwanted harmonic components of the signal output from the output unit.

Suitably, the second filter further comprises a third resonant circuit, wherein the third resonant circuit couples the second signal path between the signal path and the second resonant circuit to ground.

Suitably, the third resonant circuit comprises a third inductor connected in series with a third capacitor.

Suitably, the third resonant circuit is configured to short the first unwanted harmonic components of the signal output from the second resonant circuit to ground.

Suitably, the second filter further comprises a fourth inductor between the signal path and the third resonant circuit.

Suitably, the fourth inductor is configured to attenuate second unwanted harmonic components of the signal output from the output unit.

Suitably, the second filter further comprises a variable capacitor on the second signal path between the output unit and the second resonant circuit, the variable capacitor being controllable to short signal on the second signal path whilst the integrated circuit chip is receiving a radio frequency signal.

Suitably, the first and second filters comprise tuneable passive components which are configured to provide a different impedance when the integrated circuit chip is receiving a radio frequency signal to the impedance when the integrated circuit chip is transmitting a radio frequency signal.

Suitably, the tuneable passive components comprise a tuneable capacitor in the first filter.

Suitably, the tuneable passive components comprise a tuneable capacitor in the second filter.

Suitably, the integrated circuit chip further comprises a switch controller configured to close the first switch when the integrated circuit chip is transmitting a radio frequency signal.

Suitably, the integrated circuit chip further comprises a switch controller configured to close the second switch when the integrated circuit chip is receiving a radio frequency signal.

### BRIEF DESCRIPTION OF THE DRAWINGS

This disclosure will now be described by way of example with reference to the accompanying figures. In the figures:

FIG. 1 illustrates known transceiver circuitry utilising a differential input from a balun;

FIG. 2 illustrates exemplary transceiver circuitry;

FIG. 3 illustrates an exemplary arrangement of the first filter of FIG. 2;

FIG. 4 illustrates a further exemplary arrangement of the first filter of FIG. 2;

FIG. 5 illustrates an exemplary arrangement of the second filter of FIG. 2;

FIG. 6 illustrates a further exemplary arrangement of the second filter of FIG. 2;

FIG. 7 illustrates a further exemplary arrangement of the second filter of FIG. 2;

FIG. 8 illustrates exemplary transceiver circuitry; and

FIG. 9 illustrates exemplary transceiver circuitry.

### DETAILED DESCRIPTION

FIG. 2 illustrates the general structure of exemplary transceiver circuitry on an integrated circuit chip. Chip pin 201 is coupled to both receive circuitry and transmit circuitry. Signal path 206 from chip pin 201 divides into a first signal path 207 and a second signal path 208 at node 209. The first signal path 207 couples the signal path 206 to input unit 202. The second signal path 208 couples the signal path 206 to output unit 203.

A first filter 204 is located on the first signal path between the node 209 and the input unit 202. The received signal passes through components in the first filter 204. At node 211 between the first filter 204 and the input unit 202, a first switch 210 couples the first signal path 207 to ground. The node 211 is located on the first signal path 207 between the first filter 204 and the input unit 202. The first switch 210 is not on the first signal path 207. In other words, the first switch 210 is not in series with the first signal path 207.

A second filter 205 is located on the second signal path between the node 209 and the output unit 203. The transmitted signal passes through components in the second filter 205. At node 213 between the second filter 205 and the output unit 203, a second switch 212 couples the second signal path 208 to ground. The node 213 is located on the second signal path 208 between the second filter 205 and the output unit 203. The second switch 212 is not on the second signal path 208. In other words, the second switch 212 is not in series with the second signal path 208.

Suitably, the chip pin 201 is coupled to an antenna (not shown on FIG. 2). Suitably, no additional filtering components are located between the chip pin and the antenna. Suitably, the chip pin 201 is configured to direct rf signals received by the antenna to the input unit 202 and to direct rf signals to transmit from the output unit 203 to the antenna. Suitably, the antenna is off-chip. In other words, the antenna is outside the boundary of the integrated circuit chip. Alternatively, the antenna is on-chip. In other words, the antenna is within the boundary of the integrated circuit chip.

The first and second switches are controllable by a switch controller to isolate the input unit 202 from the output unit 203 when the integrated circuit chip is transmitting an rf signal, and to isolate the output unit 203 from the input unit 202 when the integrated circuit chip is receiving an rf signal. Suitably, the first and second switches are digitally controlled by common digital circuitry. Suitably, the first and second switches are commonly controlled such that when the first switch 210 is open the second switch 212 is closed, and when the first switch 210 is closed the second switch 212 is open.

When the integrated circuit chip is transmitting an rf signal, the second switch 212 is open. Since the second switch 212 is not in series with the second signal path 208, no power is dissipated in and no noise is added by the second switch 212 when the second switch 212 is open during transmission. When the integrated circuit chip is transmitting an rf signal, the first switch 210 is closed. This shorts any transmitted signal that has leaked into the first signal path 207 and through the first filter 204 to ground. Thus, this closed first switch 210 isolates the remainder of the receiver circuitry in input unit 202 during transmission of an rf signal.

When the integrated circuit chip is receiving an rf signal, the first switch 210 is open. Since the first switch 210 is not in series with the first signal path 207, no power is dissipated in the first switch 210 when the first switch 210 is open during reception. When the integrated circuit chip is receiving an rf signal, the second switch 212 is closed. This is related to the way one implementation of the first filter 204 operates.

Because the first switch 210 is coupled to the first signal path 207 between the input unit 202 and the first filter 204 rather than coupled to the first signal path 207 between the node 209 and the first filter 204, the transmitted signal is exposed to the circuitry of the first filter 204. Similarly, because the second switch 212 is coupled to the second signal path 208 between the output unit 203 and the second filter 205 rather than coupled to the second signal path 208 between the node 209 and the second filter 205, the received signal is exposed to the circuitry of the second filter 205.

This exposure of the first filter circuitry during transmission and the second filter circuitry during reception enables circuitry components of those filters to be utilised both for transmission and reception when otherwise they would have been duplicated in both the receive circuitry of the input unit and the transmission circuitry of the output unit. Thus, this reduces the chip area dedicated to the transceiver circuitry and reduces the power consumption of the transceiver circuitry.

Suitably, components of the first and second filter circuitries are utilised to perform the same operation during transmission and reception. For example, the first and second filters are both used to provide the desired impedance during transmission and reception. As described in more detail below, suitably some components in the first and second filters are tuneable so as to generate different transmission and reception impedances.

Suitably, components of the first and second filter circuitries are utilised to perform different operations during transmission and reception. For example, the first and second filters are both used to provide passive voltage gain to the received signal prior to that received signal being input to the input unit 202. However, during transmission, the second filter is used to attenuate unwanted harmonic components of the signal output from the output unit 203.

The following examples describe implementations of the first and second filters which achieve the characteristics described above.

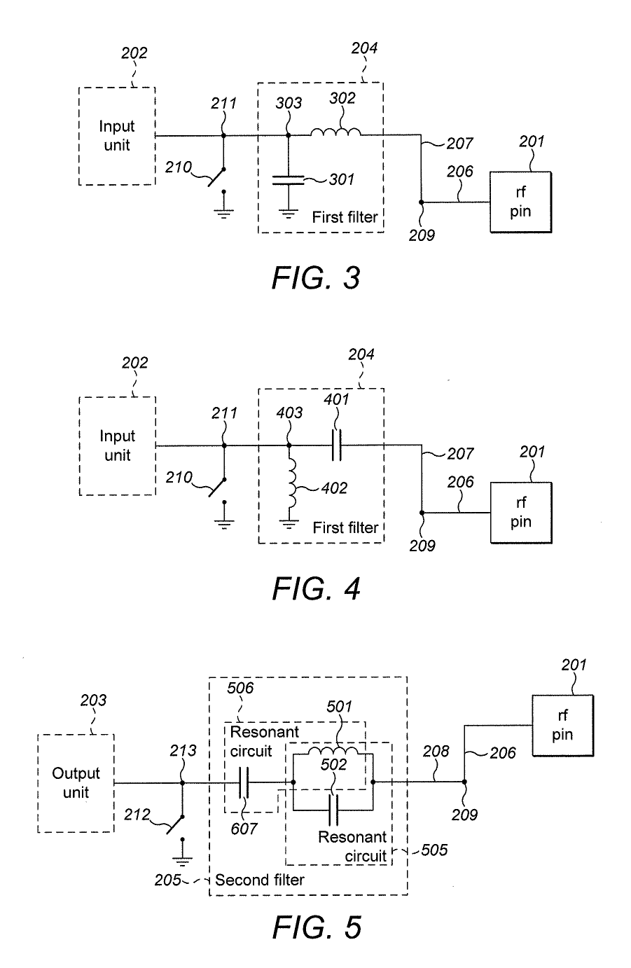

FIGS. 3 and 4 illustrate alternative exemplary arrangements of the first filter 204 of FIG. 2. FIGS. 3 and 4 illustrate only exemplary circuitry for the top half of FIG. 2 from the chip pin 201 to the input unit 202. The circuitry in the bottom half of FIG. 2 from the output unit 203 to the chip pin 201 is omitted for ease of illustration.

The first filter 204 of FIG. 3 comprises a resonant circuit. This resonant circuit comprises a capacitor 301 and an inductor 302. The inductor 302 is located on the first signal path 207. The inductor 302 is connected in series on the first signal path 207. The capacitor 301 couples the first signal path 207 at node 303 to ground. The capacitor 301 is not in series with the first signal path 207. Suitably, the capacitor 301 is a variable capacitor. The variable capacitor tunes the resonant frequency of the resonant circuit to the desired frequency of the received signal. Suitably, the inductance of the inductor 302 is variable. In one example, this is achieved by locating a variable capacitor (not shown in FIG. 3) in parallel with inductor 302. The variable inductance of the inductor 302 also tunes the resonant frequency of the resonant circuit to the desired frequency of the received signal.

FIG. 4 illustrates an alternative exemplary arrangement of the first filter 204 of FIG. 2. The first filter 204 comprises a resonant circuit. This resonant circuit comprises a capacitor 401 and an inductor 402. The capacitor 401 is located on the first signal path 207. The capacitor 401 is connected in series on the first signal path 207. The inductor 402 couples the first signal path 207 at node 403 to ground. The inductor 402 is not in series with the first signal path 207. Suitably, the inductance of the inductor 402 is variable. In one example, this is achieved by locating a variable capacitor (not shown in FIG. 4) in parallel with the inductor 402. The variable inductance of the inductor 402 tunes the resonant frequency of the resonant circuit to the desired frequency of the received signal. Suitably, the capacitor 401 is a variable capacitor. The variable capacitor also tunes the resonant frequency of the resonant circuit to the desired frequency of the received signal.

FIGS. 5, 6 and 7 illustrate alternative exemplary arrangements of the second filter 205 of FIG. 2. FIGS. 5, 6 and 7 illustrate only exemplary circuitry for the bottom half of FIG. 2 from the output unit 203 to the chip pin 201. The circuitry in the top half of FIG. 2 from the chip pin 201 to the input unit 202 is omitted for ease of illustration.

The second filter 205 of FIG. 5 comprises a resonant circuit 506. This resonant circuit is configured to be at resonance and have a low impedance at the desired transmission frequency. This resonant circuit 506 is located on the second signal path 208. The resonant circuit 506 comprises an inductor 501 and a capacitor 607 which are connected in series with each other. The capacitor 607 of resonant circuit 506 is coupled to the node 213 on the second signal path 208. The second filter 205 of FIG. 5 also comprises a resonant circuit 505. This resonant circuit 505 is configured to attenuate unwanted harmonic components of the signal output from the output unit 203. The resonant circuit 505 is located on the second signal path 208. The resonant circuit 505 comprises an inductor 501 and a capacitor 502 which are connected in parallel with each other. The resonant circuit 505 is coupled to capacitor 607 on the second signal path 208. Suitably, capacitor 607 is a variable capacitor. The capacitor 607 is configured to short signal on the second signal path 208 to ground via second switch 212 whilst the integrated circuit chip is receiving an rf signal. This might be achieved by setting the capacitance of 607 to be very high during signal reception. Suitably, capacitor 502 has a lower capacitance than the capacitance of capacitor 607. For example, capacitor 502 has a capacitance one ninth the capacitance of capacitor 607.

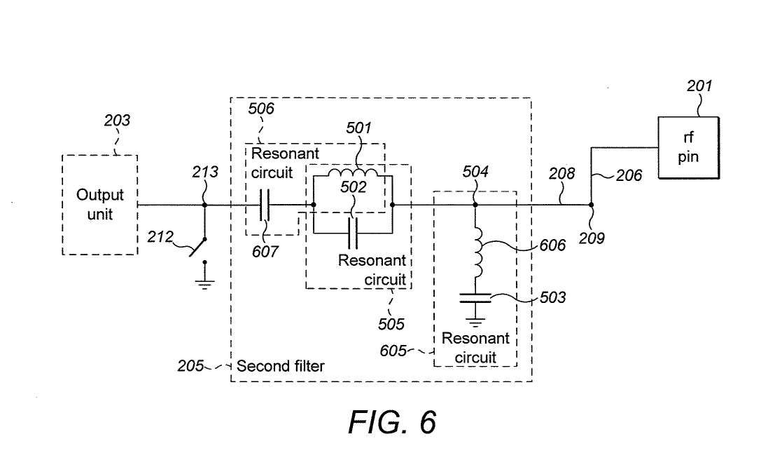

FIG. 6 illustrates an alternative exemplary arrangement of the second filter 205 of FIG. 2. The second filter 205 comprises a first resonant circuit 506 and a second resonant circuit 505 which are the same as those described with respect to FIG. 5. The second filter also comprises a third resonant circuit 605. The third resonant circuit 605 couples the second signal path 208 at node 504 to ground. Node 504 is located on the signal path 208 between the second resonant circuit 505 and the node 209. The third resonant circuit 605 comprises an inductor 606 and capacitor 503 connected in series with each other. The third resonant circuit 605 is not in series with the second signal path 208. The third resonant circuit 605 is configured to drive unwanted harmonic components of the signal output from the output unit 203 to ground. The capacitor 503 may be a variable capacitor.

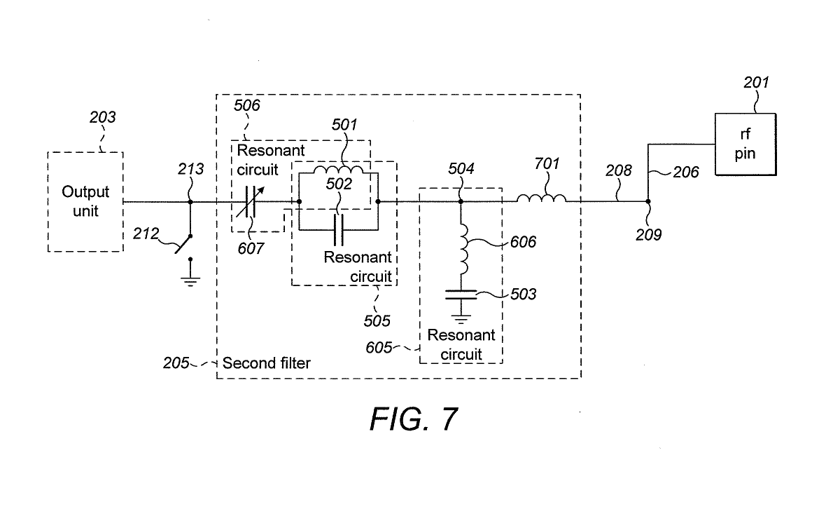

FIG. 7 illustrates an alternative exemplary arrangement of the second filter 205 of FIG. 2. The second filter 205 comprises a second resonant circuit 505 which is the same as that described with respect to FIG. 5. The second filter also comprises a third resonant circuit 605 which is the same as that described with respect to FIG. 6. The capacitor 607 of the first resonant circuit 506 of FIG. 7 is variable. The first resonant circuit 506 of FIG. 7 operates as described with respect to FIG. 5. The second filter further comprises a further inductor 701 which is located on signal path 208 between the third resonant circuit 605 and the signal path 206. In other words, this further inductor 701 is located between nodes 504 and 209 on the second signal path 208. This further inductor 701 is connected in series on the second signal path 208. This further inductor 701 is configured to attenuate unwanted harmonic components of the signal output from the output unit 203.

In a further example (not illustrated), the inductor 701 of FIG. 7 may be located in the arrangement of FIG. 5 on the second signal path 208 between the node 504 and the node 209.

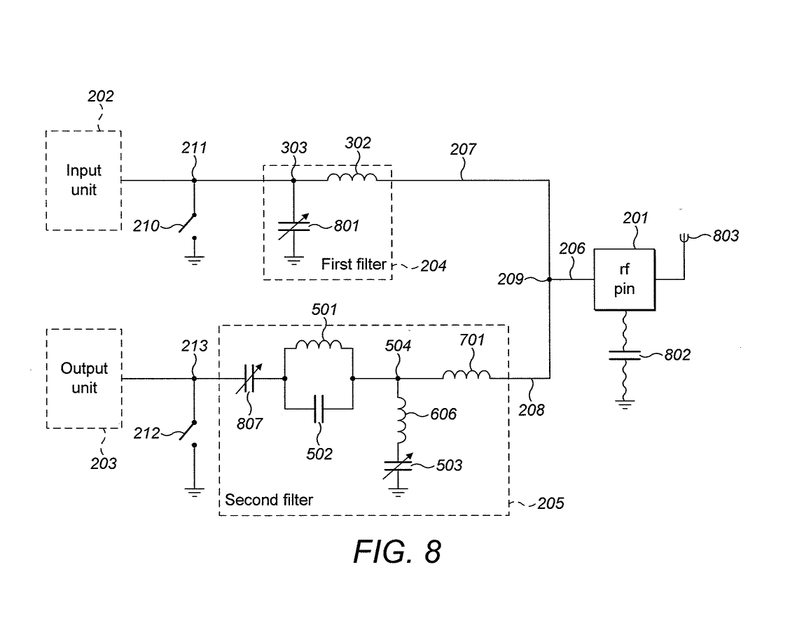

Any of the described first filter arrangements can be combined with any of the described second filter arrangements to provide the overall transceiver circuitry of FIG. 2. FIG. 8 illustrates an exemplary arrangement of the transceiver circuitry of FIG. 2. Antenna 803 is coupled to chip pin 201. Antenna 803 directs received rf signals to chip pin 201 and chip pin 201 directs rf signals to be transmitted to antenna 803. Chip pin 201 has inherent stray capacitance 802 to ground. Signal path 206 from chip pin 201 divides into first signal path 207 and second signal path 208 at node 209.

First signal path 207 couples node 209 to input unit 202. First filter 204 is located on first signal path 207 between node 209 and input unit 202. First filter comprises an inductor 302 and a variable capacitor 801. Inductor 302 is connected in series with the first signal path 207. Variable capacitor 801 couples the first signal path 207 at node 303 to ground. The variable capacitor 801 is connected to node 303 on first signal path 207 and is also connected to ground. Node 303 is on the first signal path 207 between the inductor 302 and the input unit 202. First switch 210 couples the first signal path 207 at node 211 to ground. The first switch 210 is connected to node 211 on first signal path 207 and is also connected to ground. Node 211 is on the first signal path 207 between node 303 and the input unit 202.

Second signal path 208 couples output unit 203 to node 209. Second filter 205 is located on second signal path 208 between output unit 203 and node 209. A second switch 212 couples the second signal path 208 at node 213 to ground. Second switch 212 is connected to node 213 and is also connected to ground. Node 213 is on the second signal path 208 between the output unit 203 and the second filter 205. Second filter 205 comprises variable capacitor 807. Variable capacitor 807 is on the second signal path 208 between the node 213 and the node 209. Second filter 205 also comprises an inductor 501 and capacitor 502 on the second signal path 208 between the variable capacitor 807 and the node 209. The inductor 501 and capacitor 502 are connected in parallel with each other. Second filter 205 further comprises an inductor 606 and capacitor 503 which couple second signal path 208 to ground at node 504. Inductor 606 is connected in series with capacitor 503. Inductor 606 is connected to node 504 on second signal path 208 and is also connected to capacitor 503. Capacitor 503 is connected to inductor 606 and is also connected to ground. Second filter 205 further comprises inductor 701 on the second signal path 208. Inductor 701 is connected between node 504 and node 209.

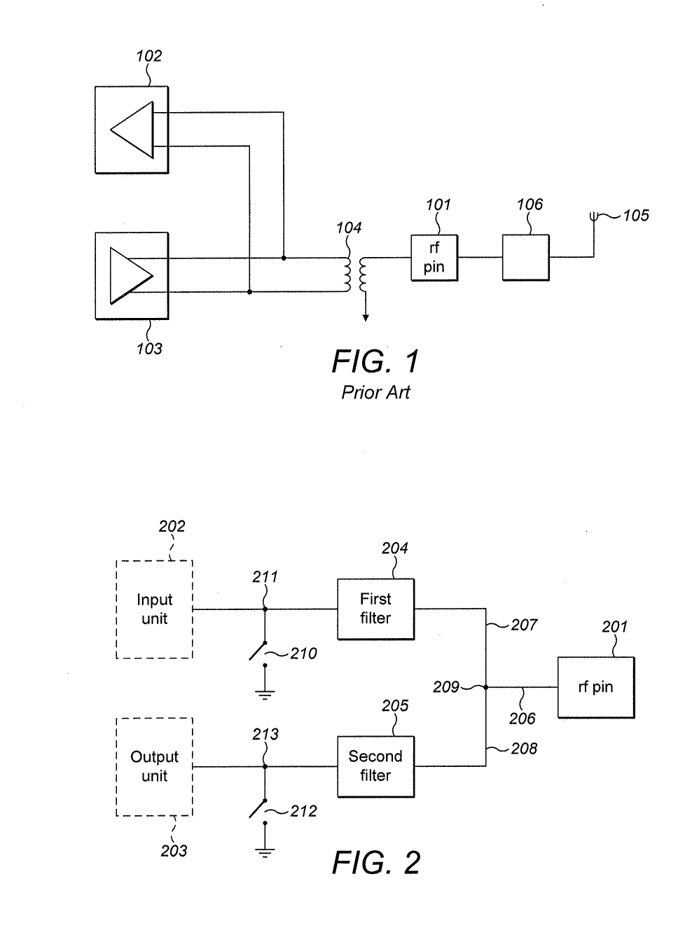

The transmit and receive circuitry of the integrated circuit chip have different preferred parameters. In particular, the impedances of the transmit and receive circuitry are different. In the arrangement of FIG. 1, the coupled transformer 104 causes the same transformation to be applied both to signals to be transmitted and to received signals. This results in both the LNA in the receive circuitry and the PA in the transmit circuitry being exposed to the same impedance.

The examples described herein enable different impedances to be applied to the transmit and receive circuitry. This is achieved by use of different inductors in the first signal path 207 and the second signal path 208, and also by utilising components in the first signal path 207 during transmission and by utilising components in the second signal path 208 during reception. Inductors 302 of the first filter 204 and 701 of second filter 205 provide a different impedance to the received signal than either of inductors 501 or 701 provides to the signal to be transmitted. During transmission, the first switch 210 is closed, which drives transmitted signal which has leaked through the first filter 204 to ground. However, the transmitted signal is exposed to the inductor 302. Since the inductor 302 is shorted at one end by the closed switch 210, it contributes a fairly high impedance during transmission.

During reception, the second switch 212 is closed. If the second filter has the component circuitry illustrated in FIG. 7 or 8, then received signal which has leaked into the second filter 205 is driven to ground effectively at node 504. This is a result of the combined low impedance of the capacitor 807 and inductor 501 pair at resonance. Thus, the received signal is exposed to inductor 701, which contributes to the impedance during reception. If the second filter has the component circuitry illustrated in FIG. 5 or 6, then received signal which has leaked into the second filter 205 is driven to ground effectively at node 213. Thus, the received signal is exposed to the remaining circuitry in the second filter 205 including the inductor 501, which contributes to the impedance during reception. One or more of variable capacitors 801, 503 and 807 are tuneable to provide a desired impedance during reception and a different desired impedance during transmission. One or more of variable capacitors 801, 503 and 807 have one value during signal reception and another value during signal transmission in order to cause the first and second filters to provide the desired impedances. Suitably, the variable capacitors 801, 503 and 807 are controlled by digital control circuitry. During transmission, a high impedance is desirable in order to achieve a target output power of the transmitted signal. Suitably, switching circuitry is used to tune the variable capacitors. Suitably, the switching circuitry used to tune capacitor 503 is configured to close the switches of the switching circuitry during transmission. This avoids introducing unwanted harmonics into the signal to be transmitted.

Variable capacitor 801 tunes the series combination of inductors 302 and 701 in FIG. 8 (or inductors 302 and 501 if the second filter has the arrangement of FIG. 5 or 6) to resonate at the desired frequency. The combination of inductors 302 and 701 in FIG. 8 (or inductors 302 and 501 if the second filter has the arrangement of FIG. 5 or 6) provides a passive voltage gain to the received signal at resonance. If the inductor 302 has an inductance L₁ and the inductor 701 has an inductance L₂ (or inductor 302 has an inductance of L₁ and inductor 501 has an inductance of L₂ if the second filter has the arrangement of FIG. 5 or 6), then the passive gain at resonance is:

gain=(L₁+L₂)/L₂ (equation 1)

This gain is an ideal value assuming that the inductors are not significantly magnetically coupled. Thus, the received signal voltage is higher at the input to the input unit 202 than at the chip pin 201. As an example, the received signal voltage is 5 times greater at the input to the input unit 202 than at the chip pin 201. By implementing passive voltage gain of the received signal, a lower current can be applied to the input unit 202, particularly to the low noise amplifier of the input unit 202.

The effective impedance during reception is:

effective impedance=ωQL₁/(gain²) (equation 2)

where ω=2πf, where f is the resonant frequency and Q is the quality factor. Thus, the desired impedance during reception is achieved by selecting the inductance values of inductors 302 and 701 (or inductors 302 and 501) appropriately.

During transmission, the output of the output unit 203 may be a square wave. The second switch 212 is open, so the signal to be transmitted passes along the second signal path 208 to capacitor 607/807. Capacitor 607/807 and inductor 501 form a series resonant pair that is tuned to the fundamental frequency of the signal to be transmitted. In other words, the capacitor 607/807 and inductor 501 together have a low impedance to the fundamental frequency of the signal to be transmitted, and thus allow those components of the signal at the fundamental frequency through.

The capacitor 502 and the inductor 501 form a parallel resonant pair that has a high impedance to a harmonic frequency of the signal to be transmitted. For example, the capacitor 502 and the inductor 501 form a high impedance to the third harmonic of the signal to be transmitted, thereby attenuating components of the signal at the third harmonic.

The inductor 606 and capacitor 503 form a series resonant pair that is tuned to a harmonic frequency of the signal to be transmitted. Suitably, the inductor 606 and capacitor 503 form a series resonant pair that is tuned to the same harmonic frequency of the signal to be transmitted as the resonant pair of the inductor 501 and capacitor 502. For example, the inductor 606 and capacitor 503 form a low impedance to the third harmonic of the signal to be transmitted, thereby shorting any components of the signal at the third harmonic to ground. In other words, the inductor 606 and capacitor 503 attenuate any remaining components of the third harmonic of the signal to be transmitted which passed through the inductor 501 and capacitor 502.

The inductor 701 attenuates a harmonic frequency of the signal to be transmitted. For example, the inductor 701 attenuates the fourth and fifth harmonics of the signal to be transmitted.

After passing through the second filter 205, the signal to be transmitted has been transformed to a sinusoidal wave from the square wave output from the output unit 203. The transformed signal to be transmitted has fewer harmonic components than the signal output from the output unit 203.

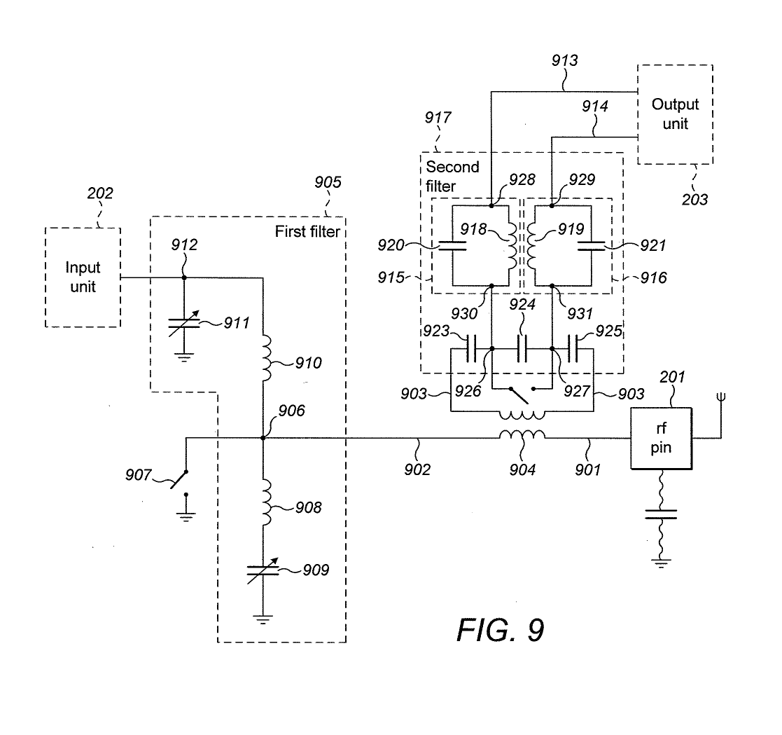

FIG. 9 illustrates further exemplary transceiver circuitry on an integrated circuit chip. Chip pin 201 is coupled to both receive circuitry and transmit circuitry. Signal path 901 from chip pin 201 divides into a first signal path 902 and a second signal path 903 at transformer 904. The first signal path 902 couples the signal path 901 via transformer 904 to input unit 202. The second signal path 903 couples the signal path 901 via transformer 904 to output unit 203.

A first filter 905 is located on the first signal path 902 between transformer 904 and input unit 202. The received signal passes through components in the first filter 905. At node 906 on first signal path 902 in the first filter 905, a switch 907 couples the first signal path 902 to ground.

First filter 905 comprises a first inductor 908 connected in series with a capacitor 909. Suitably capacitor 909 is variable. Inductor 908 is connected at one end to node 906, and at the other end to capacitor 909. Capacitor 909 is connected to inductor 908 and to ground. First filter 905 also comprises second inductor 910 and second capacitor 911. Suitably second capacitor 911 is variable. Inductor 910 is connected in series with first signal path 902 between node 906 and input unit 202. Capacitor 911 is not connected in series with first signal path 902. Node 912 is on first signal path 902 between inductor 910 and input unit 202. Capacitor 911 couples the first signal path 902 to ground at node 912.

A second filter 917 is located on the second signal path 903 between transformer 904 and output unit 203. Output unit 203 has two outputs 913 and 914. These outputs are complimentary square wave signals. Each output 913 and 914 is fed to a respective resonant circuit 915,916 in the second filter 917. Each resonant circuit 915 and 916 comprises an inductor 918,919 and a capacitor 920,921 connected in parallel to each other. The output 913 of output unit 203 connects to a node 928 between inductor 918 and capacitor 920 of resonant circuit 915. The output 914 of output unit 203 connects to a node 929 between inductor 919 and capacitor 921 of resonant circuit 916. The output of resonant circuit 915 is connected to node 930 between inductor 918 and capacitor 920. The output of resonant circuit 916 is connected to node 931 between inductor 919 and capacitor 921. The outputs of each resonant circuit 915,916 are connected by switch 922. Three capacitors 923,924,925 form a closed circuit with one inductor of transformer 904. This closed circuit is connected to the outputs of resonant circuits 915,916. Node 926 is between capacitor 923 and capacitor 924. Node 927 is between capacitor 924 and capacitor 925. Node 930 of resonant circuit 915 is connected to node 926. Node 931 of resonant circuit 916 is connected to node 927.

Inductor 910 performs the same function described with respect to inductor 302. Capacitor 911 performs the same function described with respect to capacitor 301 or 801. Inductor 908 performs the same function described with respect to inductor 606. Capacitor 909 performs the same function described with respect to capacitor 503. Switch 907 performs the same function described with respect to switch 212.

Resonant circuits 915 and 916 perform the same function described with respect to resonant circuit 505. Inductors 923, 924 and 925 in combination with the inductance of transformer 904 provide passive voltage gain to the received signal at resonance prior to that received signal being input to the input unit 202 If the capacitor 924 has a capacitance C₁, and capacitors 923 and 925 each have a capacitance C₂, then the passive gain at resonance is:

gain=2C₁/(C₂+1) (equation 3)

During reception of a signal, switch 922 is closed. This acts to short the transformer 904, second filter 917 and output unit 203 from the received signal at the wanted receive frequencies. In other words, the received signal does not see the transformer 904, second filter 917 and output unit 203. Thus, the received signal path only includes the chip pin 201, the first filter 905 and the input unit 202.

During transmission of a signal, switch 907 is closed. This acts to short the first filter 905 and input unit 202 from the transmitted signal. In other words, the transmitted signal is isolated from the first filter 905 and the input unit 202. Thus, the transmitted signal path only includes the output unit 203, the second filter 917, the transformer 904 and the chip pin 201 and the receive circuitry does not see any transmitter voltages.

The on-chip transmit and receive filtering described herein is suitable for use with radio frequency signals communicated according to any radio frequency protocol. For example, it is suitable for use with radio frequency signals communicated according to Bluetooth protocols.

In the figures described above, the input unit 202 includes receive circuitry including, for example, a low noise amplifier and automatic gain control. In the figures described above, the output unit 203 includes transmit circuitry including, for example, a power amplifier.

In the examples described above, filtering of rf signals occurs entirely on chip. No external passive filtering off-chip needs to be used. This reduces the power consumption of the passive filtering. It also reduces the product parts count dedicated to the transceiver circuitry.

The examples above describe arrangements in which two elements are coupled. This is intended to mean that those two elements are physically connected. However the two elements are not necessarily directly connected. For example, there may be intermediary elements in between the two elements which are coupled.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. An integrated circuit chip comprising:
a chip pin configured to direct radio frequency signals on and off chip;
a signal path from the chip pin which divides into a first signal path coupled to an input unit and a second signal path coupled to an output unit;
a first filter between the chip pin and the input unit on the first signal path;
a second filter between the chip pin and the output unit on the second signal path;
a first switch coupling the first signal path to ground; and
a second switch coupling the second signal path to ground;
wherein the first and second switches are controllable so as to isolate the input unit from the output unit when the integrated circuit chip is transmitting a radio frequency signal, and to isolate the output unit from the input unit when the integrated circuit chip is receiving a radio frequency signal.

2. The integrated circuit chip as claimed in claim 1, wherein the first switch couples the first signal path to ground between the input unit and the first filter.

3. The integrated circuit chip as claimed in claim 1, wherein the second switch couples the second signal path to ground between the output unit and the second filter.

4. The integrated circuit chip as claimed in claim 1, wherein the first and second filters comprise passive components which, when the integrated circuit chip receives a radio frequency signal, cause that received radio frequency signal to have a higher voltage on input to the input unit than when at the chip pin.

5. The integrated circuit chip as claimed in claim 1, wherein the first filter comprises a first resonant circuit comprising a first capacitor and a first inductor.

6. The integrated circuit chip as claimed in claim 5, wherein the first inductor is connected in series on the first signal path, and the first capacitor couples the first signal path to ground.

7. The integrated circuit chip as claimed in claim 5, wherein the first capacitor is connected in series on the first signal path, and the first inductor couples the first signal path to ground.

8. The integrated circuit chip as claimed in claim 5, wherein the first capacitor is a variable capacitor configured to tune the first filter to the received radio frequency signal.

9. The integrated circuit chip as claimed in claim 1, wherein the second filter is configured to attenuate unwanted harmonic components of a signal output from the output unit.

10. The integrated circuit chip as claimed in claim 9, wherein the second filter comprises a second resonant circuit comprising a second capacitor connected in parallel with a second inductor.

11. An integrated circuit chip as claimed in claim 10, wherein the second resonant circuit is configured to attenuate first unwanted harmonic components of the signal output from the output unit.

12. The integrated circuit chip as claimed in claim 11, wherein the second filter further comprises a third resonant circuit, wherein the third resonant circuit couples the second signal path between the signal path and the second resonant circuit to ground.

13. The integrated circuit as claimed in claim 12, wherein the third resonant circuit comprises a third inductor connected in series with a third capacitor.

14. The integrated circuit chip as claimed in claim 12, wherein the third resonant circuit is configured to short the first unwanted harmonic components of the signal output from the second resonant circuit to ground.

15. The integrated circuit chip as claimed in claim 12, wherein the second filter further comprises a fourth inductor between the signal path and the third resonant circuit.

16. The integrated circuit chip as claimed in claim 15, wherein the fourth inductor is configured to attenuate second unwanted harmonic components of the signal output from the output unit.

17. The integrated circuit chip as claimed in claim 10, wherein the second filter further comprises a variable capacitor on the second signal path between the output unit and the second resonant circuit, the variable capacitor being controllable to short signal on the second signal path whilst the integrated circuit chip is receiving a radio frequency signal.

18. The integrated circuit chip as claimed in claim 1, wherein the first and second filters comprise tuneable passive components which are configured to provide a different impedance when the integrated circuit chip is receiving a radio frequency signal to the impedance when the integrated circuit chip is transmitting a radio frequency signal.

19. The integrated circuit chip as claimed in claim 18, wherein the tuneable passive components comprise a tuneable capacitor in the first filter.

20. The integrated circuit chip as claimed in claim 18, wherein the tuneable passive components comprise a tuneable capacitor in the second filter.
